(19) United States
(12) Patent Application Publication
(10) Pub. No.: US 2006/0062883 A1
(43) Pub. Date: Mar. 23, 2006

(54) Shelf-stable moist food foam product and process for its preparation

(76) Inventors: William Hanselmann, Hershey, PA (US); Axel Mueller, Sauerlach (DE)

Correspondence Address: BELL, BOYD & LLOYD LLC, P. O. BOX 1135, CHICAGO, IL, 60690-1135, US

(21) Appl. No.: 11/274,545

(22) Filed: Nov. 15, 2005

Related U.S. Application Data
(62) Division of application No. 10/318,205, filed on Dec. 13, 2002.
Application No. 10/318,205 is a continuation of application No. PCT/EP01/06055, filed on May 28, 2001.

(30) Foreign Application Priority Data
Jun. 19, 2000 (EP) 00112892,5

(51) Int. Cl. A23L 1/00

(52) U.S. Cl. 426/564; 426/656

(57) ABSTRACT

The present invention concerns a shelf-stable moist food foam product comprising a moist, foamed food base and at least one edible partially or fully denaturated protein which stabilizes the air bubbles in the food base and which contains more than 20% water.

### CROSS-REFERENCE TO RELATED APPLICATIONS

This application is a continuation of the US national stage designation of International application PCT/EP01/06055 filed May 28, 2001, the content of which is expressly incorporated herein by reference thereto.

### BACKGROUND ART

The present invention concerns a shelf-stable moist food foam product and a process for its preparation.

Shelf-stable foam products are already known. Japanese patent application No. 58-40052 in the name of Shikishima Seipan KK discloses a process for producing an aerated dessert food in a container. The problem with the products of that patent is that they must operate with two mixtures, the first being whipped, the second not being whipped, and then both mixtures are combined and sterilized. These steps make the process complicated and expensive. Secondly, they begin with a cream, which is whipped at low temperature, and the subsequent sterilization can lead to a collapse of the resultant foam. Thirdly, the whipping is conducted with air, and this can cause oxidation of the final product.

It is also known from U.S. Pat. Nos. 3,655,405 and 4,592,919 and EP 545025 to provide a dry souffle composition that can later be made into a final product. But in this case, when the souffle is reconstituted, whipped and baked, the final product obtained exhibits an increase of its original volume.

Thus, there is a need for improved compositions of this type that do not possess the deficiencies of the prior art.

### SUMMARY OF THE INVENTION

The present invention provides a method for the manufacture of a shelf-stable moist food foam product according to an easier way than in the prior art, with a whipping step substantially without oxygen followed by allowing the whipped product to be sterilized in a safe way, that is without any risk of having a collapse of the foam. Furthermore, there is essentially no increase of the volume of the foam during the heating or sterilization steps.

The present invention also relates to a shelf-stable moist food foam product comprising a moist, foamed food base and at least one edible partially or fully denaturated protein which stabilizes the air bubbles in the food base. The product advantageously contains more than 20% water by weight. The foam product according to the invention has bubbles which are stabilized by protein denaturation at the interface of the bubbles and by a network building in the bulk.

### DETAILED DESCRIPTION OF THE PREFERRED EMBODIMENTS

By “moist” in the present specification, we mean that water is present in the final product at a level of more than 20%.

The specificity of the invention is that the moist food foam product is obtained through a heat-treatment, which is carried out after the whipping step. During this heat-treatment, the proteins reach a certain degree of denaturation, wherein film and bulk fixation and gelatinization takes place. This provides stabilization of the bubbles of the foam product and a network building in the bulk. In the present specification, heat-treatment means any treatment with an increase of the temperature above 65° C., which is the temperature at which the denaturation of the proteins begins. So it is possible according the invention to pasteurize, sterilize or make any other heat-treatment for this purpose.

The obtained moist product has a shelf-life of 3 to 18 months at room temperature. Preferably, the shelf-life is around 9 to 12 months without refrigeration and without any loss of organoleptic properties.

It is also possible according to the invention to manufacture chilled products with a milder heat-treatment, but wherein a certain denaturation of the proteins occur.

The fruit can be any type of fruit. Preferably, the fruit is selected from the group consisting of apple, cherry, strawberry, pear, banana, kiwi, peach and the like. The vegetable used can also be any type of vegetable. Preferably, the vegetable is selected from the group consisting of pea, bean, carrot, tomato, and spinach. The meat used can be any type of meat selected from the group consisting of pork, veal, beef, and chicken. The fish can be any type of fish. The milk base is either milk or a mixture of milk with water.

The edible proteins are taken from the group consisting of proteins of plant or animal origin. The edible denaturated proteins are partially or fully denaturated by heating native and partially denaturated protein alone or in mixture, with the native proteins being preferably selected from the group consisting of milk protein (whey protein and casein), egg white protein, yeast isolate, soya-bean protein, haemoglobin, plant protein isolate, meat protein, collagen, and gelatin alone or in mixtures. By partially denaturated proteins, we mean that the proteins are denaturated by at least 50%.

The amount of protein in the moist foam product can vary very broadly from 0.1 to 30% by weight based on the total weight of the final product. All the percentages are given by weight. In a preferred embodiment of the invention, the amount of protein is comprised between 1 and 5%.

The overrun of the foam product is generally between 5 and 400%. The overrun is preferably between 30 and 130%. All types of products can be considered according to the invention: baby-food products, desserts, like mousses based on milk, water or fruits, petfoods, ice cream, culinary products, like mayonnaise or mayonnaise spread and clinical nutrition products. For some of these products, like clinical nutrition products, the amount of water can be significantly higher than 20%, for example around 50 to as high as 95%.

The fruit, vegetable, meat and fish in the moist foam product can be either in the form of puree and/or pieces. The size of the pieces is not critical and can vary between 0.1 and 25 mm. The amount of fruit, vegetable, meat, fish or milk base is at least 10%. Preferably, the amount of these components is between 10 and 60%. It is also possible to consider a multi-layer product, wherein the moist foam product is one layer, the other being a layer of fruit or any other edible material.

In one embodiment, the foam product of the invention contains further a starch or a hydrocolloid. This is the case for example for a baby-food containing a starch. This starch can be a native starch or a modified starch. This starch is preferably selected from the group consisting of rice, maize, corn, or semolina starch. In the case of a dessert, the foam product contains a hydrocolloid. This hydrocolloid is preferably selected from the group consisting of xanthan, carragheenan, and guar gums. In the case of a clinical nutrition product, both hydrocolloids and starch are present.

It is possible for the moist food foam product to contain an oil and/or fat. Preferably, the oil is either sunflower oil or rapeseed oil.

The moist foam product could optionally contain an aroma, a coloring agent, chocolate, caramel, sugar, or acids.

The amount of water in the product is around 40 to 95%. The pH of the moist foam product of the invention is generally between 3 and 7.

The measure of the denaturation of a native protein is related to IDF/FIL, Norme 178A:1999 based on the article of Resmini P., Pellegrino L., Hogenboom J. A., Andreini R., Thermal denaturation of whey protein in pasteurized milk. Fast evaluation by HPLC, Ital. J. Food Sci. 2:51-62 (1989).

The invention concerns further a process for the preparation of a shelf-stable moist food foam product described here above, comprising:

whipping a mixture comprising at least one edible protein and a food base to produce a whipped moist foam,

filling the whipped moist foam into a container and sealing or closing the container, and

heating the closed or sealed container to partially or fully denaturate the edible protein to stabilize the moist foam.

The edible proteins for carrying out the process are taken from the group consisting of a native protein or a partially denaturated protein, either alone or in mixture. The amount of the native protein is at least 30%, based on the total weight of the proteins. The native proteins used are the same as mentioned here above in relation with the shelf stable moist food foam product.

As already mentioned, according to the invention, all the components are mixed together and then the whipping is conducted. It is possible to work in a continuous way with a line, which is simple and very efficient in terms of productivity.

As already mentioned in relation with the product, the whipping is carried out to reach an overrun of 5 to 400%. Preferably, the overrun is between 30 and 130%. The heat-treatment is carried out for the denaturation of the proteins at a temperature between 65 and 145° C. The duration of this heat-treatment is around 1 min to 10 hours. The protein fixation at the interface and the network building in the bulk is performed already at 65° C., but for a complete denaturation, a longer time is needed.

It is possible according to the process of the invention to partially or totally denature the proteins. For example, in the case of a partial denaturation, a heat-treatment can be carried out at 100° C. for 10 min. Under such conditions, an interfacial and bulk fixation and gelatinization is already built up and bubble stability reaches a sufficient level. The resulting product must be stored chilled at 4° C., if not acid. A good example of this type is a chilled fish mousse.

The heat-treatment is preferably carried out at a temperature between 100 and 125° C. for a period of 20 to 40 min.

The whipping is carried out under a nitrogen, CO₂, N₂O, O₂ atmosphere or a mixture of them at a maximum temperature of 60° C. Preferably, the whipping is carried out at a temperature around room temperature, i.e. in the area of 20 to 30° C. Preferably, the whipping is carried out with nitrogen.

In the case of the presence in the mixture of a native starch or a modified starch, it is preferred to proceed before the whipping to a pre-heating. This pre-heating is carried out at a temperature of up to 85° C. for several minutes. The mixture is then cooled down and the whipping is conducted. This pre-heating is not necessary in the case of the use of specific starches.

The filling in the containers is made under normal conditions, because of the heat-treatment after filling. The containers are normally closed or closed by the sealing of a lid, for example an aluminum lid. The containers used can be either cans, plastic containers, glass jars, tubular bags or any other available type of packaging. Preferably, plastic containers are used. Normally, oxygen barrier materials are used. For example, it is preferred to use a 3 layer material such as PP/EVOH/PP to reduce oxygen ingress into the package.

The invention concerns further a method of providing to the consumer a moist food foam product in a container which is shelf stable without refrigeration. This gives to the consumer a great advantage of having a moist foamed product that does not need a storage in a refrigerator.

### EXAMPLE

The present invention is further illustrated by the following example.

### Example 1

Carrots are cut into pieces of 10 mm and cooked in water at a temperature of 85° C. Starch is dissolved in water, mixed with the semolina and added to the carrots. A heating is then carried out and the mixture is cooled down. Whey protein isolate is dissolved in water and added to the carrots as well as all other ingredients.

The carrots are mixed with the whey protein isolate and a whipping is carried out to an overrun of 50%.

The foam product is filled in plastic containers, sealed and a heat-treatment is carried out in-pack at 121° C. for 20 min.

The bubbles in the foam remain after the heat-treatment and the product is shelf-stable at room temperature during 12 months without any negative influence on the organoleptic properties.

The final product has following composition:

| | |
|---|---|
| Carrot | 50% |
| Apple puree | 10% |
| Whey protein isolate | 5% |
| Starch | 3% |
| Rice semolina | 3% |
| Sugar | 1.5% |
| Water | 28.5% |

1-11. (canceled)

12. A process for the preparation of a shelf-stable moist food foam product which comprises: whipping a mixture comprising at least one edible protein and a food base to produce a whipped moist foam, filling the whipped moist foam into a container and sealing or closing the container, and heating the closed or sealed container to partially or fully denaturate the edible protein to stabilize the moist foam.

13. The process according to claim 12, wherein the edible protein is selected from the group consisting of a native protein, a partially denaturated protein or a mixture thereof.

14. The process according to claim 12, wherein the whipping is carried out to produce an overrun of 30 to 130% in the product.

15. The process according to claim 12, wherein the heat-treatment is carried at a temperature of between 65 and 145° C.

16. The process according to claim 12, wherein the heat-treatment is carried out for 1 min. to 10 hours.

17. The process according to claim 12, wherein the whipping is carried out at a maximum temperature of 60° C. with nitrogen gas.

18. The process according to claim 17, wherein the whipping is carried out at a temperature of 20 to 30° C.

19. The process according to claim 12, which further comprises pre-heating at least one of the protein or food base before whipping the mixture.

20. The process according to claim 12, wherein the containers are plastic containers, cans, glass jars, or tubular bags.

21. (canceled)
